(19) United States
(12) Patent Application Publication
(10) Pub. No.: US 2025/0084933 A1
(43) Pub. Date: Mar. 13, 2025

(54) DEFLECTION WHEEL

(71) Applicant: iPEK International GmbH, Sulzberg (DE)

(72) Inventors: Johannes Wiese, Immenstadt (DE); Andreas Becherer, Waltenhofen (DE); Thomas Oesterle, Mittelberg (AT); Sebastian Felder, Hirschegg (AT); Alexander Stoll, Oberreute (DE); Christian Schiebel, Marktoberdorf (DE)

(21) Appl. No.: 18/883,962

(22) Filed: Sep. 12, 2024

(30) Foreign Application Priority Data
Sep. 13, 2023 (DE) 10 2023 124 726.3

(51) Int. Cl. F16L 3/015

(52) U.S. Cl. CPC F16L 3/015

(57) ABSTRACT

A deflection device is provided for deflecting an elongated, flexible molded body from a shaft into a canal branching off therefrom, wherein the deflection device comprises
two spreading arms, which are connected to each other in an articulated manner at a first hinge point, and
two spreading levers, which are connected to each other in an articulated manner at a second hinge point,
wherein
the two spreading levers are each connected with their free ends in an articulated manner to a respective spreading arm at a pivot point.

### CROSS-REFERENCE TO RELATED APPLICATIONS

This application claims priority to German Patent Application Serial No. DE 10 2023 124 726.3, filed Sep. 13, 2023, the entire disclosure of which is hereby incorporated herein by reference in its entirety.

### FIELD OF THE INVENTION

The invention relates to a deflection device for deflecting an elongated, flexible molded body, such as a hose, from a manhole into a sewer branching off therefrom.

### BACKGROUND OF THE INVENTION

Deflection devices for deflecting a hose or a cable from a manhole into a sewer branching off therefrom are used in sewer inspection and/or maintenance systems in order to make better guidance of the hose or cable possible on the one hand and to prevent damage to the hose or cable on the other hand.

A hose guide for a sewer inspection and/or maintenance system for deflecting a hose leading to an inspection and/or maintenance device from a manhole into a sewer is known from EP 3 252 242. The hose guide has a specific radius of curvature such that a front portion of the hose guide protrudes into the sewer and a rear portion of the guide device protrudes into the manhole. The banana-like design of the hose guide allows the hose to be deflected without the hose touching the wall of the sewer or manhole in the deflection region.

The disadvantage here, however, is that the banana-shaped hose guide substantially hangs freely in the manhole, which can lead to the hose guide being pulled completely into the sewer or completely into the manhole by the hose. Safe deflection without the hose touching the wall of the sewer or manhole cannot always be guaranteed. If the cable or hose is not under tension, it can also happen that the hose guide settles on the bottom of the sewer. If the hose or cable is then subjected to tension again, it is necessary to take great care to ensure that the hose guide is correctly positioned in the deflection region again.

### OBJECT OF THE INVENTION

The object of the invention is therefore to provide a solution with which in particular a hose or a cable can be easily and at the same time safely deflected from a manhole into a sewer branching off therefrom.

### SUMMARY OF THE INVENTION

This object is achieved with a deflection device for deflecting an elongated, flexible molded body from a manhole into a sewer branching off therefrom according to the independent claim. Advantageous embodiments of the invention are specified in the dependent claims.

Accordingly, a deflection device is provided for deflecting an elongated, flexible molded body from a manhole into a sewer branching off therefrom, wherein the deflection device comprises
a first spreading arm and a second spreading arm, the two spreading arms being connected to one another in an articulated manner at a first hinge point, and
a first spreading lever and a second spreading lever, the two spreading levers being connected to one another in an articulated manner at a second hinge point,
wherein
   the first spreading lever is connected with its free end in an articulated manner to the first spreading arm at a first pivot point, the first pivot point being arranged on the first spreading arm between the first hinge point and the free end of the first spreading arm,
   the second spreading lever is connected with its free end in an articulated manner to the second spreading arm at a second pivot point, the second pivot point being arranged on the second spreading arm between the first hinge point and the free end of the second spreading arm, and
   a rotatably mounted deflection pulley (deflection wheel) is arranged in the region of the free end of the first spreading arm.

It is advantageous if the position of the first pivot point on the first spreading arm, the position of the second pivot point on the second spreading arm, the length of the first spreading lever and the length of the second spreading lever are coordinated with one another such that an increase in the first angle formed by the two spreading levers causes an increase in the second angle formed by the two spreading arms.

In one embodiment of the invention, a traction means, in particular a traction cable, rod, tube or telescopic tube, can be fastened in the region of the second hinge point, with which traction means the region of the second hinge point can be subjected to a tensile force acting in the direction of the first hinge point, wherein the distance between the second hinge point and the first hinge point is reduced by subjecting the region of the second hinge point to the tensile force.

In an alternative embodiment of the invention, an actuating means, which acts on the first hinge point and the second hinge point and with which the distance between the first hinge point and the second hinge point can be changed, can be arranged between the first hinge point and the second hinge point.

The actuating means can be a hydraulic cylinder, a pneumatic cylinder or a spindle.

Stopping means can be arranged on at least one of the spreading arms and/or on at least one of the spreading levers, which stopping means prevent an increase in the first angle, formed by the two spreading levers, beyond the dead center of the spreading levers. The stopping means can be designed, for example, as pins.

It can be advantageous if the two spreading arms have a corrugated or at least a rough surface on the outer sides in the region of their end portions. Alternatively or additionally, an anti-slip and preferably abrasion-resistant material, such as rubber, can be provided or arranged on the outer sides of these end portions.

The corrugated surface can be formed by transverse grooves or a sawtooth profile.

A hook can be arranged on the free end of at least one spreading arm, which hook preferably projects at a right angle from the spreading arm.

At least one spreading arm can comprise two segments spaced apart from one another and coupled to one another, wherein the deflection pulley is arranged between the two segments. The segments are arranged substantially in parallel with one another.

It may be advantageous if at least one guiding means is provided radially outside the deflection pulley and at a certain distance from the deflection pulley, wherein the elongated, flexible molded body can be guided between the guiding means and the deflection pulley. The guiding means may be subjected to a spring force acting in the direction of the deflection pulley.

It may be advantageous if the two spreading arms and/or the two spreading levers are assigned a locking means, with which the spreading arms and/or the spreading levers can be locked in a predetermined position relative to one another. The spreading arms and/or the spreading levers can be locked in a spread state to prevent the angle between the spreading arms and/or the angle between the spreading levers from changing automatically. This makes it possible for the deflection device, once it has been fixed in the manhole or sewer, to remain in this spread state.

The elongated, flexible molded body may be a hose, in particular a high-pressure hose, or a cable.

### BRIEF DESCRIPTION OF THE DRAWINGS

Further details and features of the invention as well as specific, in particular advantageous exemplary embodiments of the invention become apparent from the following description in conjunction with the drawing. In the figures:

FIGS. 1A and 1B show a deflection device according to the invention in a perspective view and in a side view, in a spread state;

FIGS. 2A and 2B show a deflection device according to the invention in a perspective view and in a side view, in a non-spread (folded) state;

FIGS. 3A and 3B show a detail of the deflection device according to the invention in a perspective view and in a side view;

FIG. 4 is a side view of the deflection device according to the invention; and

FIG. 5 shows a deflection device according to the invention arranged in a manhole/sewer.

### DETAILED DESCRIPTION OF THE INVENTION

The solution according to the invention makes it possible to fix the deflection device to the manhole bottom. This ensures safe, defined and low-friction guidance of a cable or hose during a sewer inspection and/or maintenance, even if the hose/cable is not under tension. A further advantage is that the deflection device can be used for different manhole diameters and still ensures secure fixation.

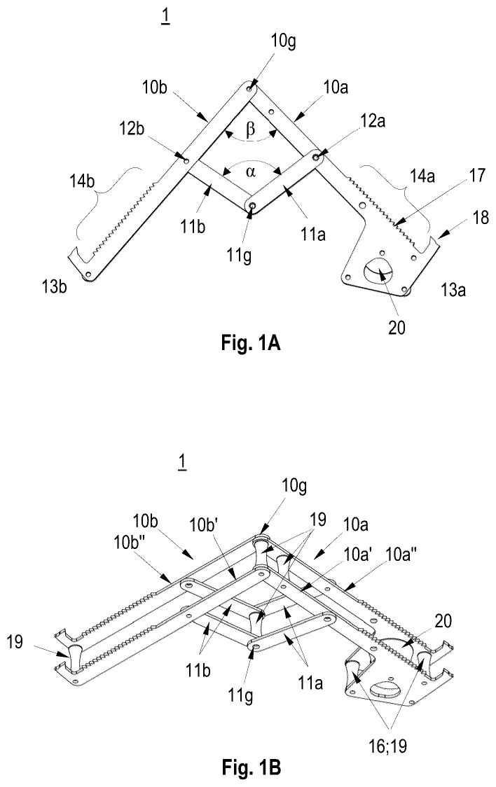

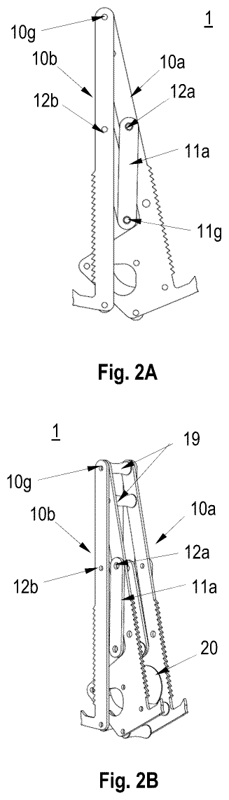

FIGS. 1A-2B show a deflection device 1 according to the invention in a side view (FIGS. 1A and 2A) and in a perspective view (FIGS. 1B and 2B), wherein the deflection device is shown in FIGS. 1A and 1B in a spread state and in FIGS. 2A and 2B in a non-spread state.

The deflection device 1 comprises two spreading arms, namely, a first spreading arm 10a and a second spreading arm 10b. The two spreading arms 10a, 10b are connected to one another in an articulated manner at a first hinge point 10g, i.e., the angle β between the two spreading arms 10a, 10b is variable so that the two spreading arms 10a, 10b can be brought into a spread position (as shown in FIGS. 1A and 1B) and into a non-spread (folded) position (as shown in FIGS. 2A and 2B).

Between the two spreading arms 10a, 10b, a type of spreading or lever mechanism is arranged, with which the spreading of the spreading arms 10a, 10b is accomplished. This spreading or lever mechanism comprises a spreading lever 11a and a second spreading lever 11b, wherein the two spreading levers 11a, 11b are connected to one another in an articulated manner at a second hinge point 11g such that an angle α between the two spreading levers 11a, 11b can be changed.

The first spreading lever 11a is connected with its free end in an articulated manner to the first spreading arm 10a at a first pivot point 12a, and the second spreading lever 11b is connected with its free end in an articulated manner to the second spreading arm 10b at a second pivot point 12b. This forms a kind of scissor mechanism, with which the spreading arms 10a, 10b can be brought into the spread position or into the non-spread position.

Here, the first pivot point 12a is arranged on the first spreading arm 10a between the first hinge point 10g and the free end 13a of the first spreading arm 10a. The second pivot point 12b is arranged on the second spreading arm 10b between the first hinge point 10g and the free end 13b of the second spreading arm 10b. The spreading arms 10a, 10b and the spreading levers 11a, 11b thus form a diamond so that together they form the aforementioned scissor mechanism.

By changing the angle α formed by the two spreading levers 11a, 11b, the angle β formed by the two spreading arms 10a, 10b also changes, whereby (depending on the change in the angle β) the spreading arms 10a, 10b are brought into the spread position or into the non-spread position.

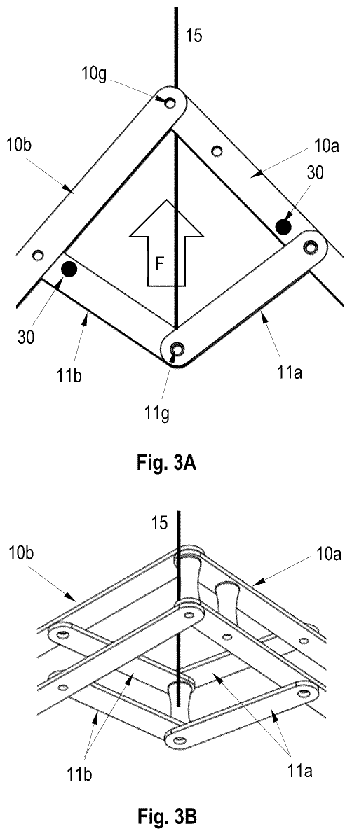

However, it is advantageous if
the position of the first pivot point 12a on the first spreading arm 10a,
the position of the second pivot point 12b on the second spreading arm 10b,
the length of the first spreading lever 11a, and
the length of the second spreading lever 11b
are coordinated with one another such that an increase in the angle α formed by the two spreading levers 11a, 11b causes an increase in the second angle β formed by the two spreading arms 10a, 10b, as shown in FIG. 1A. This ensures safe spreading of the two spreading arms 10a, 10b, in particular when using a traction cable, as described with reference to FIGS. 3A and 3B.

The two spreading arms 10a; 10b have a corrugated surface 17 on the outer sides in the region of their end portions 14a, 14b. The corrugated surface 17 can be formed by transverse grooves or a sawtooth profile. If the deflection device is in the spread state in the manhole bottom, slipping of the deflection device can thus be prevented. However, other designs of the outer sides of the end portions 14a, 14b are possible; for example, the outer sides of the end portions 14a, 14b can comprise an anti-slip material, such as rubber.

On the free end 13a of the spreading arm 10a, a hook 18 is arranged, which here projects outward from the spreading arm at a right angle. The hook can be used to lower an inspection and/or maintenance device together with the deflection device 1 into the sewer. This allows two otherwise separate work steps to be combined into one work step. In the same way, this hook can be used to pull the device together with the deflection device 1 back out. A corresponding hook can additionally or alternatively also be provided on the free end 13b of the second spreading arm 10b.

As can be seen in FIGS. 1B, 2B, and 3B, at least one spreading arm 10a, 10b comprises two segments 10a′; 10a″; 10b′; 10b″ spaced apart from one another and coupled to one another, wherein the deflection pulley 20 (deflection wheel) is arranged between the two segments. In the embodiment of the invention shown in FIGS. 1A-2B, both spreading arms 10a, 10b comprise corresponding segments, wherein the deflection pulley is arranged between the two segments 10a′; 10a″ of the first spreading arm 10a.

The segments 10a′; 10a″ or 10b′; 10b″ of a spreading arm 10a, 10b are substantially identical in design and arranged in parallel with one another and are kept at a distance by means of spacers 19 arranged therebetween. Accordingly, the spreading levers 11a, 11b can each consist of two identically designed segments, which are arranged in parallel with one another and are kept at a distance by means of spacers 19.

A spacer 19 is arranged here in the region of the first hinge point 10g of the spreading arms and can thus simultaneously take over the function of a hinge axis for the two spreading arms or accommodate a hinge axis running between the spreading arms.

A further spacer 19 is arranged here in the region of the second hinge point 11g of the spreading levers and can thus simultaneously take over the function of a hinge axis for the two spreading levers or accommodate a hinge axis running between the spreading levers.

The distance between the segments 10a′; 10a″ of the first spreading arm 10a is smaller than the distance between the segments 10b′; 10b″ of the second spreading arm 10b (or vice versa). This allows the first spreading arm to engage in the second spreading arm when folded, so that a very compact shape of the deflection pulley can be achieved in the folded position.

A rotatably mounted deflection pulley 20 is arranged in the region of the free end 13a of the first spreading arm 10a. This deflection pulley can alternatively also be arranged on the free end 13b of the second spreading arm 10b. In yet another alternative embodiment, two deflection pulleys can also be provided, with one deflection pulley each being arranged on the free end 13b of the second spreading arm 10b and on the free end 13a of the first spreading arm 10a. The deflection pulley can be designed as a cylinder that is rotatably mounted on a manhole. Other designs of the deflection pulley 20 are possible.

A first guiding means 16a can be provided radially outside the deflection pulley 20 and at a certain distance from the deflection pulley (see in particular in FIG. 1B). The first guiding means 16a runs transversely between the two segments 10a′, 10a″ of the first spreading arm 10a. In one embodiment of the invention, the first guiding means 16a can also be formed by a spacer 19. The first guiding means 16a ensures that a cable or a hose largely rests on the deflection pulley even in the unloaded state (where “largely” in this context means that the cable/hose in the unloaded state moves away from the deflection pulley beyond a certain distance).

In addition, a second guiding means 16b can be provided, which is also arranged radially outside the deflection pulley 20 and at a certain distance from the deflection pulley and runs transversely between the two segments 10a′, 10a″ of the first spreading arm 10a. This allows a cable/hose to be held even better on the deflection pulley and be guided better around the deflection pulley. The second guiding means 16b can also be formed by a spacer 19.

In one embodiment of the invention, the first guiding means 16a and/or the second guiding means 16b can be designed as rotatably mounted guiding means.

In yet another embodiment of the invention, the first guiding means 16a and/or the second guiding means 16b can be subjected to a force (e.g., spring force), which presses the respective guiding means in the direction of the deflection pulley 20. A cable or hose running between the deflection pulley and the guiding means is pressed against the guide roller. This makes it even easier to ensure that a cable or hose is always guided precisely and safely around the deflection pulley.

The guiding means can also simultaneously take over the function of the aforementioned spacers.

FIGS. 3A-3B shows a detail of the deflection device according to the invention in a side view (FIG. 3A) and in a perspective view (FIG. 3B) for illustrating the functioning of the deflection device according to the invention.

In the region of the second hinge point 11g, a traction means 15 can be fastened, with which the region of the second hinge point 11g can be subjected to a tensile force F acting in the direction of the first hinge point 10g. The traction means can be a cable (traction cable) or a telescopic tube or a rod. When the deflection device is arranged in the manhole, the traction means is led out of the manhole so that a person on the surface can operate the traction means 15.

If the traction means is pulled upward, the region of the second hinge point 11g is subjected to a tensile force F directed upward and thus acting in the direction of the first hinge point 10g, as indicated by the arrow. As a result, the distance between the second hinge point 11g and the first hinge point 10g is reduced (the angles α and β shown in FIG. 1 are increased), which causes the two spreading arms 10a, 10b to spread.

If the traction means is lowered again, the process is reversed (the angles α and β shown in FIG. 1A decrease) and the two spreading arms 10a, 10b are folded back together.

In one embodiment of the invention, the traction means can be fastened directly to the spacer 19, which is arranged in the region of the second hinge point 11g or forms the hinge axis of the spreading levers 11a, 11b.

In an alternative embodiment of the invention (not shown in the figures), an actuating means 16 acting on the first hinge point 10g and the second hinge point 11g can be arranged between the first hinge point 10g and the second hinge point 11g. The actuating means is designed to change the distance between the first hinge point 10g and the second hinge point 11g, wherein a change in this distance has the same effect as described above for the traction cable. The actuating means can, for example, be a hydraulic cylinder, pneumatic cylinder or a spindle. According to the invention, any actuating means with which the distance between the first hinge point 10g and the second hinge point 11g can be changed can be used.

It is advantageous if stopping means 30 are arranged on at least one of the spreading arms 10a, 10b and/or on at least one of the spreading levers 11a, 11b, which stopping means prevent an increase in the first angle α, formed by the two spreading levers 11a, 11b, beyond the dead center of the spreading levers 11a, 11b. The distance between the two hinge points 10g and 11g cannot fall below a certain value. This prevents the two spreading arms 10a, 10b from remaining in their spread position when the traction means 15 is lowered, because the distance between the two hinge points 10g and 11g does not increase again. Furthermore, this prevents the two spreading arms 10a, 10b from folding together automatically due to their weight and leverage when the dead center is exceeded.

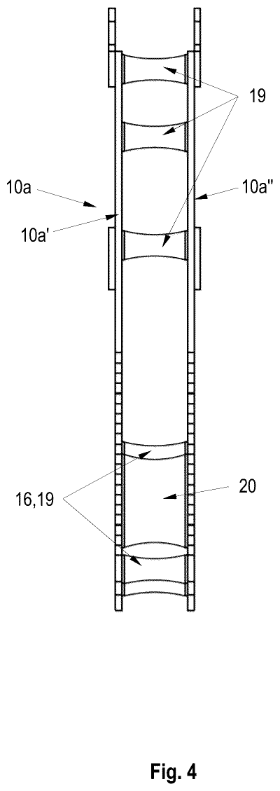

FIG. 4 shows a side view of the deflection device according to the invention, wherein only the spreading arm 10a shown in FIGS. 1A-2B is shown here.

Visible are the parallel segments 10a′, 10a″ of the spreading arm 10a and the spacers 19 arranged between the two segments as well as the deflection pulley arranged on the free end of the spreading arm 10a, which deflection pulley is rotatably mounted between the two segments 10a′, 10a″.

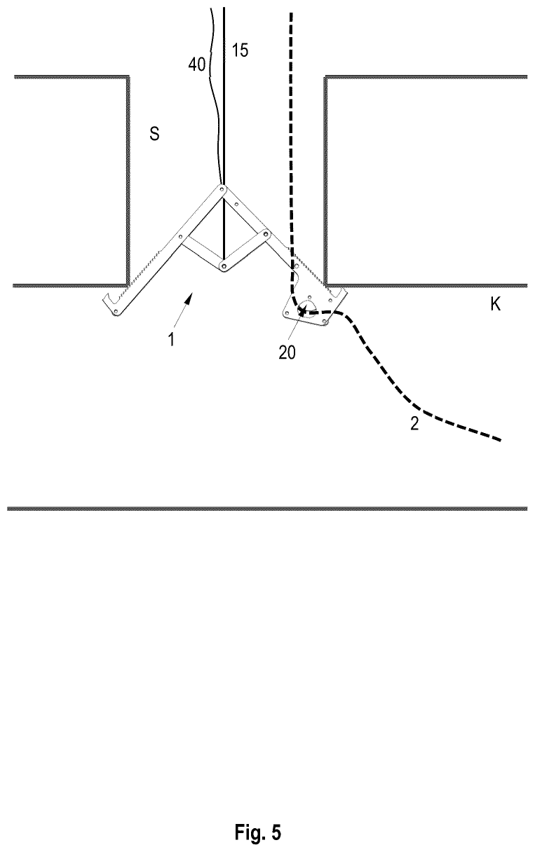

FIG. 5 shows a deflection device 1 according to the invention arranged in a manhole S/sewer K.

The deflection device is in a spread position here. The two end portions 14a, 14b of the spreading arms 10a, 10b rest on the transition edge between the manhole and the sewer. Due to the tensile force F of the traction means 15 (a traction cable is shown here), the two end portions of the spreading arms are pressed against this transition edge, thus preventing the deflection device from being pulled back out of the manhole due to the tensile force. The deflection device is thus in a braced position in the manhole, in which position a cable or a hose can be safely guided around the deflection pulley of the deflection device. The guiding means 16a and/or 16b prevent a cable/hose from sagging downward in the region of the guide roller.

If the traction means is relaxed, the two spreading arms 10a, 10b fold together and the deflection device can be pulled out of the manhole with a lowering cable 40.

As an example, the course of a hose 2 or a cable 2 through the deflection device or around the deflection pulley is shown here as a dotted line.

We claim:

1. A deflection device for deflecting an elongated, flexible molded body from a manhole into a sewer branching off therefrom, wherein the deflection device comprises
a first spreading arm and a second spreading arm, the two spreading arms being connected to one another in an articulated manner at a first hinge point, and
a first spreading lever and a second spreading lever, the two spreading levers being connected to one another in an articulated manner at a second hinge point,
wherein
the first spreading lever is connected with its free end in an articulated manner to the first spreading arm at a first pivot point, the first pivot point being arranged on the first spreading arm between the first hinge point and the free end of the first spreading arm,
the second spreading lever is connected with its free end in an articulated manner to the second spreading arm at a second pivot point, the second pivot point being arranged on the second spreading arm between the first hinge point and the free end of the second spreading arm, and
a rotatably mounted deflection pulley is arranged in the region of the free end of the first spreading arm.

2. The deflection device according to claim 1, wherein the position of the first pivot point on the first spreading arm, the position of the second pivot point on the second spreading arm, the length of the first spreading lever and the length of the second spreading lever are coordinated with one another such that an increase in the first angle formed by the two spreading levers causes an increase in the second angle formed by the two spreading arms.

3. The deflection device according to claim 1, wherein, in the region of the second hinge point, a traction means, in particular a traction cable or telescopic tube, is fastened, with which the region of the second hinge point can be subjected to a tensile force acting in the direction of the first hinge point, wherein the distance between the second hinge point and the first hinge point is reduced by subjecting the region of the second hinge point to the tensile force.

4. The deflection device according to claim 1, wherein an actuating means acting on the first hinge point and the second hinge point is arranged between the first hinge point and the second hinge point, with which actuating means the distance between the first hinge point and the second hinge point can be changed.

5. The deflection device according to claim 4, wherein the actuating means is a hydraulic cylinder, pneumatic cylinder or a spindle.

6. The deflection device according to claim 1, wherein stopping means are arranged on at least one of the spreading arms and/or on at least one of the spreading levers and prevent an increase in the first angle, formed by the two spreading levers, beyond the dead center of the spreading levers.

7. The deflection device according to claim 1, wherein the two spreading arms have a corrugated surface on the outer sides in the region of their end portions.

8. The deflection device according to claim 7, wherein the corrugated surface is formed by transverse grooves or a sawtooth profile.

9. The deflection device according to claim 1, wherein a hook is arranged on the free end of at least one spreading arm, which hook preferably projects at a right angle from the spreading arm.

10. The deflection device according to claim 1, wherein at least one spreading arm comprises two segments spaced apart from one another and coupled to one another, wherein the deflection pulley is arranged between the two segments.

11. The deflection device according to claim 1, wherein a guiding means is provided radially outside the deflection pulley and at a certain distance from the deflection pulley, wherein the elongated, flexible molded body can be guided between the guiding means and the deflection pulley.

12. The deflection device according to claim 1, wherein the molded body is a hose or a cable.
